(19) United States
(12) Patent Application Publication
(10) Pub. No.: US 2014/0171262 A1
(43) Pub. Date: Jun. 19, 2014

(54) ELECTRIC 4-WHEEL DRIVE SYSTEM

(71) Applicant: HYUNDAI MOTOR COMPANY, SEOUL (KR)

(72) Inventor: Ji-Yoel Joeng, Gyeonggi-do (KR)

(73) Assignee: HYUNDAI MOTOR COMPANY, SEOUL (KR)

(21) Appl. No.: 13/951,885

(22) Filed: Jul. 26, 2013

(30) Foreign Application Priority Data
Dec. 18, 2012 (KR) 10-2012-0148745

(51) Int. Cl. B60W 10/02; B60W 10/08

(52) U.S. Cl. CPC B60W 10/02; B60W 10/08
USPC 477/8

(57) ABSTRACT

An electric 4-wheel drive system that delivers electromotive force to a rear wheel in a vehicle using a front engine front-wheel drive. The system includes a motor that has a hollow type rotating shaft, wherein a rear-wheel drive shaft is inserted into the hollow of the rotating shaft. In addition, the system includes a one-way clutch that is installed within the hollow, combined with the rear-wheel drive shaft and the rotating shaft, and is configured to selectively block rotary power delivered from the rotating shaft to the rear-wheel drive shaft.

### CROSS-REFERENCE TO RELATED APPLICATION

This application claims priority to and the benefit of Korean Patent Application No. 10-2012-0148745 filed in the Korean Intellectual Property Office on Dec. 18, 2012, the entire contents of which are incorporated herein by reference.

### BACKGROUND

(a) Field of the Invention

The present invention relates to an electric 4-wheel drive system. More particularly, the present invention relates to a clutch for selectively blocking the power delivery of a motor and a wheel drive shaft.

(b) Description of the Related Art

In general, an electric 4-Wheel Drive (e-4WD) system is an apparatus capable of simultaneously obtaining a 4WD function and a hybrid electric vehicle (HEV) function by driving the rear wheel of a vehicle having a front engine front-wheel drive by way of a motor. The electric 4-wheel drive system drives the motor using redundant power of the engine. The electric 4-wheel drive system has been applied to vehicles and is mass-produced by automobile makers.

The electric 4-wheel drive system can be manufactured in a more cost efficient manner compared to hybrid vehicle or a fuel cell vehicle with a high capacity battery. The electric 4-wheel drive system obtains necessary power from a high-capacity electric generator and drives the motor using the power. In a vehicle that utilizes the electric 4-wheel drive system, the power of an engine and the power of a transmission are connected to a front wheel. Such a vehicle includes an electric generator that converts mechanical energy, that is, redundant power of the engine, into electrical energy. A motor and a decelerator driven by electrical energy generated from the electric generator are disposed on a part of a rear wheel of the vehicle, and the outputs of the motor and the decelerator can be delivered to the rear wheel via the drive shaft.

As described above, the electric 4-wheel drive system can improve fuel consumption due to reduction of the weight of the vehicle by the omission of a propeller shaft and can minimize a power loss when the vehicle is driven.

This electric 4-wheel drive system includes a clutch that blocks power delivered from the motor to the drive shaft when vehicle speed by front-wheel drive is about 130 KPH or more. In particular, the clutch releases a connection between the motor and the drive shaft and prevents the driving torque of the drive shaft from being delivered to the motor by way of a slip (or free-wheeling), thereby preventing damage to the motor due to the driving torque of the drive shaft.

In addition, the clutch may include a multi-plate clutch, that is, a complicated and mechanical combination body, for example. The multi-plate clutch is installed in the power delivery path of the motor and the drive shaft as an additional element. However, the electric 4-wheel drive system is disadvantageous in terms of weight, a cost, a size, and fuel consumption and a control structure that operates the clutch is complicated when this clutch is adopted.

The above information disclosed in this section is only for enhancement of understanding of the background of the invention and therefore it may contain information that does not form the prior art that is already known in this country to a person of ordinary skill in the art.

### SUMMARY

The present invention provides an electric 4-wheel drive system that has advantages in terms of weight, a cost, a size, and fuel consumption and has an advantage of a simple structure for controlling a clutch by installing a simplified one-way clutch in a portion where the rotary power of a motor is generated.

An exemplary embodiment of the present invention provides an electric 4-wheel drive system that provides electromotive force to a rear wheel in a vehicle using a front engine front-wheel drive, including a motor that has a hollow type rotating shaft, a rear-wheel drive shaft inserted into the hollow of the rotating shaft, and a one-way clutch installed within the hollow, combined with the rear-wheel drive shaft and the rotating shaft, and configured to selectively block rotary power delivered from the rotating shaft to the rear-wheel drive shaft.

The one-way clutch may include an outer race that corresponds with the rotating shaft, an inner race that corresponds with the rear-wheel drive shaft, and a plurality of ball members installed in respective mounting grooves, formed at predetermined intervals along a race direction of the outer race in an interior circumference of the outer race, via a plurality of respective springs.

In addition, the one-way clutch may be configured to selectively block the rotary power delivered from the rotating shaft to the rear-wheel drive shaft by an angular speed difference between the outer race and the inner race. The one-way clutch may be configured to deliver the rotary power of the rotating shaft to the rear-wheel drive shaft when the angular speed difference between the outer race and the inner race is greater than 0. Further, the one-way clutch may be configured to block the rotary power delivered from the rotating shaft to the rear-wheel drive shaft when the angular speed difference between the outer race and the inner race is less than 0.

The motor may include an in-wheel motor connected to the rear-wheel drive shafts. The motor may additionally include an in-line motor configured to distribute the rotary power over the rear-wheel drive shafts on left and right sides.

An exemplary embodiment of the present invention has advantages in terms of weight, a cost, a size, and fuel consumption and a structure that operates a clutch is simplified by omitting the existing multi-plate clutch and includes a simplified one-way clutch.

### BRIEF DESCRIPTION OF THE DRAWINGS

The following drawings are illustrated in order to refer to a description of some exemplary embodiments of the present invention, and the technical spirit of the present invention should not be construed as being limited to the accompanying drawings.

FIG. 1 is an exemplary block diagram schematically showing a construction of an electric 4-wheel drive system in accordance with an exemplary embodiment of the present invention;

FIG. 2 is an exemplary diagram showing a one-way clutch applied to the electric 4-wheel drive system in accordance with an exemplary embodiment of the present invention;

FIGS. 3 and 4 are exemplary diagrams showing an operating state of the one-way clutch applied to the electric 4-wheel drive system in accordance with an exemplary embodiment of the present invention; and

FIG. 5 is an exemplary block diagram schematically showing a construction of an electric 4-wheel drive system in accordance with another exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, fuel cell vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In order to clarify a description of the present invention, parts not related to the description are omitted, and the same reference numbers are used throughout the drawings to refer to the same or like parts. Furthermore, a description of parts which may be easily understood by those skilled in the art is omitted.

The size and thickness of each of elements shown in the drawings are randomly illustrated for convenience of description and thus the present invention is not limited to those shown in the drawings. In the drawings, a thickness is enlarged in order to clearly show several parts and areas.

Furthermore, in the following detailed description, terms denoting the names of elements, such as the first and the second, are provided to distinguish the elements from each other because the elements have the same construction, and the elements are not limited to corresponding order in the following description.

In the entire specification, unless explicitly described to the contrary, the word “comprise” and variations, such as “comprises” or “comprising”, will be understood to imply the inclusion of stated elements but not the exclusion of any other elements. Furthermore, each of terms, such as ‘. . . unit”, “. . . means’, ‘. . . part’, and ‘. . . member’ described in the specification, mean a unit of a comprehensive element that performs at least one function or operation.

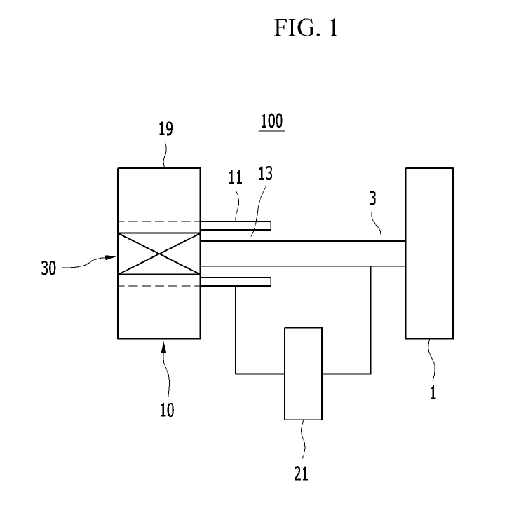

FIG. 1 is an exemplary block diagram schematically showing a construction of an electric 4-wheel drive system in accordance with an exemplary embodiment of the present invention. Referring to FIG. 1, the electric 4-wheel drive system 100 may be applied to a hybrid vehicle that utilizes the torque of an engine as main power and the torque of a motor 10, driven by electrical energy, as auxiliary power. For example, the electric 4-wheel drive system 100 may be applied to a vehicle that utilizes a front engine front-wheel drive that drives a front wheel using the power of an engine and drives a rear wheel 1 using the rotary power of the motor 10.

The vehicle using a front engine front-wheel drive may include an electric generator that converts mechanical energy, that is, redundant power of the engine, into electrical energy on the front wheel side.

The electric 4-wheel drive system 100 may be configured to drive the rear wheel 1 using the rotary power of the motor 10 in a vehicle using a front engine front-wheel drive and may secure climbing performance in a low speed section when a slip is generated in the front wheel. In addition, the electric 4-wheel drive system 100 may be an in-wheel motor type in which the motor 10 is installed on each rear wheel 1 side and the rotary power of the motor 10 is provided to the rear wheel 1.

The electric 4-wheel drive system 100 in accordance with an exemplary embodiment of the present invention may be configured to omit the existing multi-plate clutch, that is, a clutch that blocks power delivered from the motor 10 to the drive shaft of the rear wheel 1 to protect the motor 10 when vehicle speed by front-wheel drive is about 130 KPH or higher. That is, the system may eliminate the existing multi-plate clutch that has a complicated structure, heavy weight, and a large size and may provide the electric 4-wheel drive system 100 that uses a simplified clutch. Therefore, the electric 4-wheel drive system 100 in accordance with an exemplary embodiment of the present invention may include the motor 10 and a one-way clutch 30 installed within the motor 10.

The motor 10 may be configured to provide rotary power to the rear wheels 1 on the left and right sides of a vehicle using a front engine front-wheel drive and may include a hollow type rotating shaft 11. As is well known in the art, this motor 10 is also called a ‘hollow type motor.’ Here, a rear-wheel drive shaft 3 may be disposed within the hollow 13 of the hollow type rotating shaft 11. In particular, the motor 10 may be a plurality of in-wheel motors 19 connected to the respective rear-wheel drive shafts 3 on the left and right sides of a vehicle using a front engine front-wheel drive.

Furthermore, a deceleration apparatus 21 may be connected to the rotating shaft 11 of the motor 10. The deceleration apparatus 21 may be configured to reduce power delivered from the hollow type rotating shaft 11 of the motor 10 and may increase torque by reducing the power from the hollow type rotating shaft 11 of the motor 10 before delivering the power to the rear-wheel drive shaft 3. The deceleration apparatus 21 may be formed as a deceleration apparatus that is well known in the art to which the present invention pertains, for example, a deceleration gear group, and thus a detailed description of the construction of the deceleration apparatus 21 is omitted in the present specification.

In an exemplary embodiment of the present invention, the one-way clutch 30 may be configured to selectively block the rotary power delivered from the hollow type rotating shaft 11 of the motor 10 to the rear-wheel drive shaft 3. The one-way clutch 30 may be inserted into the hollow 13 of the hollow type rotating shaft 11 to be installed therein and may be coupled with the hollow type rotating shaft 11 and the rear-wheel drive shaft 3.

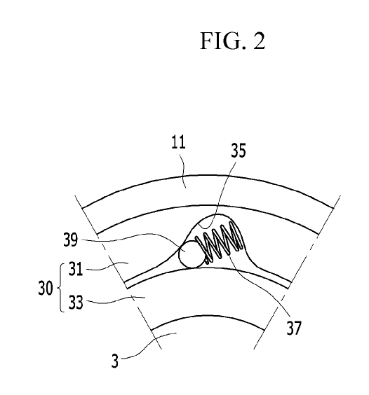

FIG. 2 is an exemplary diagram showing a one-way clutch applied to the electric 4-wheel drive system in accordance with an exemplary embodiment of the present invention.

Referring to FIG. 2, the one-way clutch 30 may include an outer race 31 corresponding with the interior circumference of the rotating shaft 11, an inner race 33 corresponding with the exterior circumference of the rear-wheel drive shaft 3, and ball members 39 installed in respective mounting grooves 35, formed at predetermined intervals along the race direction of the outer race 31 in the interior circumference thereof, via respective springs 37.

In particular, the exterior circumference of the outer race 31 may correspond with the interior circumference of the rotating shaft 11, and the interior circumference of the inner race 33 may correspond with the exterior circumference of the rear-wheel drive shaft 3. A first side of each spring 37 may be supported by the ball members 39, and a second side of each spring 37 may be supported by the interior surface of the mounting groove 35.

In an exemplary embodiment of the present invention, the one-way clutch 30 may be configured to selectively block rotary power delivered from the rotating shaft 11 of the motor 10 to the rear-wheel drive shaft 3 using an angular speed difference between the outer race 31 and the inner race 33. In other words, when an angular speed difference between the outer race 31 and the inner race 33 is greater than 0, the one-way clutch 30 may be configured to deliver the rotary power of the rotating shaft 11 to the rear-wheel drive shaft 3. Furthermore, when an angular speed difference between the outer race 31 and the inner race 33 is less than 0, the one-way clutch 30 may be configured to block the rotary power delivered from the rotating shaft 11 to the rear-wheel drive shaft 3.

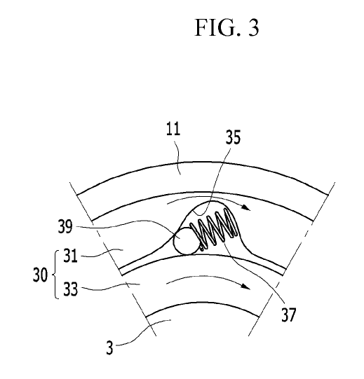

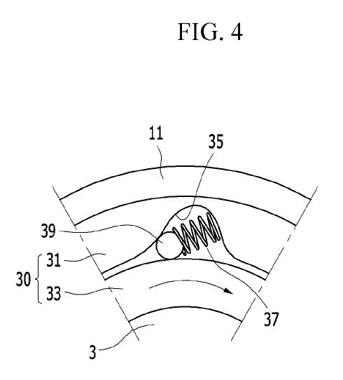

An operation of the electric 4-wheel drive system 100 constructed as described above in accordance with an exemplary embodiment of the present invention is described in detail below with reference to FIGS. 3 and 4. FIGS. 3 and 4 are exemplary diagrams showing an operation of the one-way clutch 30 applied to the electric 4-wheel drive system in accordance with an exemplary embodiment of the present invention.

Referring to FIG. 3, in an exemplary embodiment of the present invention, when an angular speed of the outer race 31 rotated by the rotating shaft 11 of the motor 10 is greater than an angular speed of the inner race 33 rotated by the rear-wheel drive shaft 3, the rotary power of the rotating shaft 11 may be delivered to the rear-wheel drive shaft 3. In particular, the ball members 39 between the outer race 31 and the inner race 33 unite the outer race 31 and the inner race 33 and may deliver the torque of the outer race 31 to the inner race 33, so the rotary power of the rotating shaft 11 may be delivered to the rear-wheel drive shaft 3.

Accordingly, when vehicle speed by front-wheel drive in an exemplary embodiment of the present invention is less than about 130 KPH, the rotary power of the motor 10 may be delivered to the rear-wheel drive shaft 3, and thus, the rear wheels 1 on the left and right sides may be driven by the driving torque of the rear-wheel drive shaft 3.

In contrast, referring to FIG. 4, in an exemplary embodiment of the present invention, when an angular speed of the outer race 31 rotated by the rotating shaft 11 of the motor 10 is less than an angular speed of the inner race 33 rotated by the rear-wheel drive shaft 3, the rotary power delivered from the rotating shaft 11 to the rear-wheel drive shaft 3 may be blocked. In particular, the ball members 39 between the outer race 31 and the inner race 33 may release the constraint of the outer race 31 using the torque of the inner race 33, to block the rotary power delivered from the rotating shaft 11 to the rear-wheel drive shaft 3.

Accordingly, in an exemplary embodiment of the present invention, when vehicle speed by front-wheel drive is about 130 KPH or more, the rotary power delivered from the rotating shaft 11 to the rear-wheel drive shaft 3 may be blocked as described above. Accordingly, the driving torque of the rear-wheel drive shaft 3 may not be delivered to the motor 10 by way of a slip (or free-wheeling).

As described above, in an exemplary embodiment of the present invention, when vehicle speed by front-wheel drive is about 130 KPH or more, only the rear wheel 1 may be rotated at substantially high speed and the driving torque of the rear wheel 1 may not be delivered to the motor 10 via the rear-wheel drive shaft 3. Accordingly, damage to the motor due to the driving torque of the rear wheel 1 may be prevented.

As described above so far, according to an exemplary embodiment of the present invention, since the one-way clutch 30 may be installed at the portion where the rotary power of the motor 10 is generated, the existing multi-plate clutch configured to have a complicated structure and installed in the power delivery path of the motor and the rear wheel as an additional component may be eliminated.

Accordingly, an exemplary embodiment of the present invention has advantages in terms of weight, a cost, a size, and fuel consumption and a structure that operates a clutch is simplified due to eliminating the existing multi-plate clutch and utilizing a simplified one-way clutch 30.

As described above, in an exemplary embodiment of the present invention, the one-way clutch 30 has been illustrated as being installed within the rotating shaft 11 of the motor 10, but is not limited thereto. For example, the one-way clutch 30 may be installed within the deceleration apparatus 21 to reduce the rotary power of the motor 10. In other words, the one-way clutch 30 may be installed within the rotation power output unit (not shown) of the deceleration apparatus 21 and a portion to which the rear-wheel drive shaft 3 is connected.

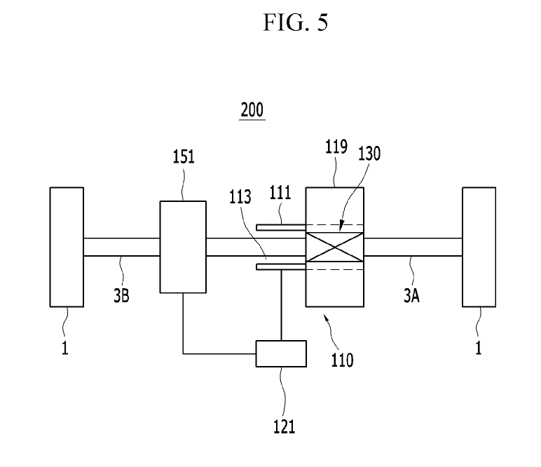

FIG. 5 is an exemplary block diagram schematically showing a construction of an electric 4-wheel drive system in accordance with another exemplary embodiment of the present invention.

Referring to FIG. 5, the electric 4-wheel drive system 200 may be configured based on an in-line method of driving rear wheels 1 on the left and right sides by using one motor 110, unlike the in-wheel method according to the aforementioned exemplary embodiment in which motors are installed in the driving rear wheels 1 on the left and right sides. In other words, the motor 110 in accordance with another exemplary embodiment of the present invention may be provided as an in-line motor 119 to provide rotary power to the rear wheels 1 on the left and right sides via a power delivery apparatus.

Accordingly, in the electric 4-wheel drive system 200 in accordance with another exemplary embodiment of the present invention, the first rear-wheel drive shaft 3A of the rear wheel 1 on one side may be disposed within the hollow 113 of the rotating shaft 111 of the motor 110. The first rear-wheel drive shaft 3A may be connected to a differential apparatus 151 as a power delivery apparatus, and the second rear-wheel drive shaft 3B of the rear wheel 1 on the other side may be connected to the differential apparatus 151.

Meanwhile, a deceleration apparatus 121 as a power delivery apparatus that reduces the rotary power of the rotating shaft 111 and delivers the reduced rotary power to the differential apparatus 151 may be installed within the rotating shaft 111 of the motor 110. This differential apparatus 151 may be formed of a differential apparatus that is widely known in the art to which the present invention pertains, for example, a differential apparatus of a velvet gear type, and a further detailed description thereof is omitted in the present specification.

In an exemplary embodiment of the present invention, a one-way clutch 130 combined with the rotating shaft 111 and the first rear-wheel drive shaft 3A may be installed within the hollow 113 of the rotating shaft 111. In the electric 4-wheel drive system 200 configured as described above in accordance with another exemplary embodiment of the present invention, the construction and acting effects of the one-way clutch 130 may be the same as those of the aforementioned exemplary embodiment, and thus a further description thereof is omitted.

While this invention has been described in connection with what is presently considered to be exemplary embodiments, it is to be understood that the invention is not limited to the disclosed embodiments, but, on the contrary, is intended to cover various modifications and equivalent arrangements included within the spirit and scope of the accompanying claims.

Description of symbols

| | |
|---|---|
| 1: rear wheel | 3, 3A, 3B: rear-wheel drive shaft |
| 10, 110: motor | 11, 111: rotating shaft |
| 13, 113: hollow | 19: in-wheel motor |
| 21, 121: deceleration apparatus | 30, 130: one-way clutch |
| 31: outer race | 33: inner race |
| 35: mounting groove | 37: spring |
| 39: ball member | 119: in-line motor |
| 151: differential apparatus | |

What is claimed is:

1. An electric 4-wheel drive system that provides electromotive force to a rear wheel in a vehicle using a front engine front-wheel drive, comprising:
a motor including a hollow type rotating shaft, wherein a rear-wheel drive shaft is inserted into a hollow of the rotating shaft; and
a one-way clutch installed within the hollow, combined with the rear-wheel drive shaft and the rotating shaft, and configured to selectively block rotary power delivered from the rotating shaft to the rear-wheel drive shaft.

2. The electric 4-wheel drive system of claim 1, wherein the one-way clutch includes:
an outer race that corresponds with the rotating shaft;
an inner race that corresponds with the rear-wheel drive shaft, wherein the outer race and the inner race are separated by mounting grooves; and
a plurality of ball members installed in respective mounting grooves, formed at predetermined intervals along a race direction of the outer race in an interior circumference of the outer race, using a plurality of respective springs.

3. The electric 4-wheel drive system of claim 2, wherein the one-way clutch is configured to selectively block the rotary power delivered from the rotating shaft to the rear-wheel drive shaft using an angular speed difference between the outer race and the inner race.

4. The electric 4-wheel drive system of claim 1, wherein the one-way clutch is configured to deliver the rotary power of the rotating shaft to the rear-wheel drive shaft when the angular speed difference between the outer race and the inner race is greater than 0.

5. The electric 4-wheel drive system of claim 4, wherein the one-way clutch is configured to block the rotary power delivered from the rotating shaft to the rear-wheel drive shaft when the angular speed difference between the outer race and the inner race is less than 0.

6. The electric 4-wheel drive system of claim 1, wherein the motor includes an in-wheel motor connected to the rear-wheel drive shafts.

7. The electric 4-wheel drive system of claim 1, wherein the motor includes an in-line motor that distributes the rotary power over the rear-wheel drive shafts on left and right sides of the vehicle.
